(19) United States
(12) Patent Application Publication
(10) Pub. No.: US 2009/0296004 A1
(43) Pub. Date: Dec. 3, 2009

(54) Information processing device and information processing method

(75) Inventor: Yuichiro TAKAMIZAWA, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/454,939

(22) Filed: May 27, 2009

(30) Foreign Application Priority Data
May 30, 2008 (JP) P2008-141773

(51) Int. Cl. H04N 5/44; G09G 5/08; G06F 3/00

(52) U.S. Cl. 348/734; 345/157; 715/716; 348/E05.096

(57) ABSTRACT

An information processing device of the present invention includes: a display portion that displays an image; a remote control information receiving portion that receives operation information transmitted from an external operation device; a content determination portion that determines, based on the received operation information, an instructed position and an operation content that are instructed by the external operation device with respect to the display portion; a cursor screen inside-outside determination portion that determines whether the instructed position is on an inside of the display portion; and a screen outside operation portion that performs control such that an action in accordance with the instructed position and the operation content is performed when it is determined that the instructed position is on an outside of the display portion.

### BACKGROUND OF THE INVENTION

1. Field of the Invention

The present invention generally relates to an information processing device and an information processing method. More specifically, the present invention relates to an information processing device and an information processing method that are operable by an external operation device such as a remote controller.

2. Description of the Related Art

Generally, devices like a television receiver and a recording/replay device can be operated by a remote controller. The remote controller is an operation device for operating a device or piece of equipment at a position remote from the main body of the device or piece of equipment. The remote controller is provided with, for example, one or more buttons that are each associated with a predetermined process. A user can cause the device or piece of equipment to perform the predetermined process by pressing a predetermined button.

Recently, as a result of an increase in functions of devices like a television receiver and a recording/replay device, remote controllers have been provide with many buttons. As a result, the user sometimes has trouble finding a button to perform a predetermined process, and has to perform troublesome operations. Moreover, if a plurality of external input terminals are provided on the main body of the television receiver, the recording/replay device or the like, one or more external connection devices can be connected to the main body. When switching to a desired external input terminal from the main body is performed in order to use an external connection device connected to the main body, the user needs to perform a plurality of operations, such as pressing a button a plurality of times, resulting in troublesome operations.

In order to eliminate such troublesome operations of a remote controller, a method has been proposed in which a free cursor remote controller is used. A free cursor is a mechanism that selects an icon displayed on a screen, and the free cursor can be freely moved on the screen by the remote controller (see, for example, Japanese Patent Application Publication No. JP-A-2006-245721). The free cursor can be operated by using a button for up, down, left and right movement that is provided on the remote controller, or by moving the remote controller itself. As a method for simplifying operations of a television receiver etc. by using a remote controller that can operate the free cursor, there is a known method in which a predetermined action, such as inclining the remote controller, is associated in advance with a predetermined process (see, for example, Japanese Patent Application Publication No. JP-A-2006-222613).

### SUMMARY OF THE INVENTION

However, in the method described in Japanese Patent Application Publication No. JP-A-2006-245721, even if the free cursor is used as a cursor for selecting an icon displayed on the screen, another operation, such as pressing a predetermined button, is required for icon selection or the like. As a result, troublesome operations are required. In the method described in Japanese Patent Application Publication No. JP-A-2006-222613, if various processes are assigned to actions relating to the remote controller, the user has to memorize many actions. As a result, the operation becomes more complicated.

The present invention addresses the problems described above and provides an information processing device and an information processing method that are new and improved and that are capable of simplifying the operation of a device or piece of equipment using a remote controller.

According to an embodiment of the present invention, there is provided an information processing device that includes: a display portion that displays an image; a receiving portion that receives operation information transmitted from an external operation device; a content determination portion that determines, based on the received operation information, an instructed position and an operation content that are instructed by the external operation device with respect to the display portion; a screen inside-outside determination portion that determines whether the instructed position is on an inside of the display portion; and a screen outside operation portion that performs control such that an action in accordance with the instructed position and the operation content is performed when it is determined that the instructed position is on an outside of the display portion.

According to the above embodiment of the present invention, when the information processing device is operated by the external operation device, the content determination portion determines the instructed position at which the external operation device is pointed and the operation content input from the external operation device. The screen inside-outside determination portion determines whether the instructed position is on the inside of the display portion. When it is determined that the instructed position is on the outside of the display portion, the screen outside operation portion performs control such that an action in accordance with the instructed position and the operation content is performed. In this manner, the information processing device is operated in accordance with the instructed position at which the external operation device is pointed with respect to the information processing device. Therefore, the user can intuitively operate the information processing device, and operation can be simplified.

The screen outside operation portion may include: an action information memory portion that stores at least one piece of registration information in which the instructed position and the operation content are associated with action control information that indicates an action content that is performed with respect to the information processing device; and an action information acquisition portion that acquires, from the action information memory portion, the action control information corresponding to the instructed position and the operation content based on the operation information received from the external operation device. Thus, a desired action can be performed on the information processing device, based on the instructed position and the operation content based on the operation information.

The action information acquisition portion may search the action information memory portion for registration information that matches the operation content based on the operation information and that is similar to the instructed position based on the operation information, and may acquire action control information of the corresponding registration information. Given that it is difficult to point the external operation device precisely at a particular position, even when the instructed position does not completely match the instructed position of the registration information, it is determined that the instructed position that indicates the vicinity of the instructed position of the registration information also matches the instructed position of the registration information.

Further, the action information acquisition portion may search the action information memory portion for registration information indicating that a distance from the instructed position based on the operation information is the closest possible and equal to or less than a predetermined distance, and may acquire action control information of the corresponding registration information. When the condition for matching of the instructed position is loosened, the instructed position instructed by the external operation device is more likely to match the instructed position of the registration information. However, there is a possibility that a plurality of pieces of registration information will match the search condition. In this case, the registration information that matches the user's operation can be extracted by extracting, for example, the registration information indicating that a distance between the instructed position instructed by the external operation device and the instructed position of the registration information is the closest possible and equal to or less than the predetermined distance, as the one that matches the search condition.

The action control information may be input switching information that switches an input between the information processing device and a device connected to the information processing device. In this case, when the instructed position and the operation content based on the operation information correspond to a predetermined instructed position and a predetermined operation content on the outside of the display portion that have been associated in advance with the input switching information, the action information acquisition portion acquires the input switching information from the action information memory portion and switches the input between the information processing device and the device connected to the information processing device.

The action control information may be channel selection information that selects a channel of the information processing device. In this case, when the instructed position and the operation content based on the operation information correspond to a predetermined instructed position and a predetermined operation content on the outside of the display portion that have been associated in advance with the channel selection information, the action information acquisition portion acquires the channel selection information from the action information memory portion and selects the channel.

The action control information may be sound volume adjustment information that adjusts a sound volume of the information processing device. In this case, when the instructed position and the operation content based on the operation information correspond to a predetermined instructed position and a predetermined operation content on the outside of the display portion that have been associated in advance with the sound volume adjustment information, the action information acquisition portion acquires the sound volume adjustment information from the action information memory portion and adjusts the sound volume.

The content determination portion may include: a position determination portion that determines, based on the operation information, an instructed position that indicates a position at which the external operation device is pointed with respect to the display portion; and an operation content determination portion that determines, based on the operation information, an operation content performed with respect to the external operation device by a user. In this case, the position determination portion may use, as a measure for determination, one of a Euclidian distance and a Manhattan distance to indicate the instructed position.

The information processing device of the present invention may further include a screen inside operation portion that operates a cursor that is displayed on the display portion based on the instructed position and the operation content when it is determined that the instructed position is on the inside of the display portion. Thus, when it is determined that the instructed position is on the outside of the display portion, the screen outside operation portion can be used for operation. Meanwhile, when it is determined that the instructed position is on the inside of the display portion, the screen inside operation portion can be used for operation.

According to another embodiment of the present invention, there is provided an information processing method that includes the steps of: receiving operation information transmitted from an external operation device; determining, based on the received operation information, an instructed position and an operation content that are instructed by the external operation device; determining whether the instructed position is on an inside of a display portion that displays an image; and performing control such that an action in accordance with the instructed position and the operation content is performed when it is determined that the instructed position is on an outside of the display portion.

According to the embodiments of the present invention, an information processing device and an information processing method can be provided that are capable of simplifying the operation of a device or piece of equipment using a remote controller.

### BRIEF DESCRIPTION OF THE DRAWINGS

FIG. 1 is an explanatory diagram illustrating a positional relationship between a television receiver, a remote controller, and an external device according to an embodiment of the present invention;

FIG. 2 is a block diagram showing a schematic configuration of the television receiver according to the embodiment;

FIG. 3 is a block diagram showing the configurations of an operation control portion and the remote controller according to the embodiment;

FIG. 4 is a plan view showing an example of the remote controller according to the embodiment;

FIG. 5A is an explanatory diagram showing a setting menu screen that is displayed on a display portion when device control information is registered in a position/operation memory portion;

FIG. 5B is an explanatory diagram showing a remote control setting screen that is displayed on the display portion when the device control information is registered in the position/operation memory portion;

FIG. 5C is an explanatory diagram showing a new registration screen that is displayed on the display portion when the device control information is registered in the position/operation memory portion;

FIG. 5D is an explanatory diagram showing another example of the new registration screen that is displayed on the display portion when the device control information is registered in the position/operation memory portion;

FIG. 5E is an explanatory diagram showing an instruction screen that is displayed on the display portion when the device control information is registered in the position/operation memory portion;

FIG. 6 is an explanatory diagram showing relative positions with respect to the television receiver;

FIG. 7 is a flowchart showing an operation control process performed by the operation control portion according to the embodiment; and

FIG. 8 is an explanatory diagram illustrating a direction in which the remote controller is pointed toward the television receiver.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

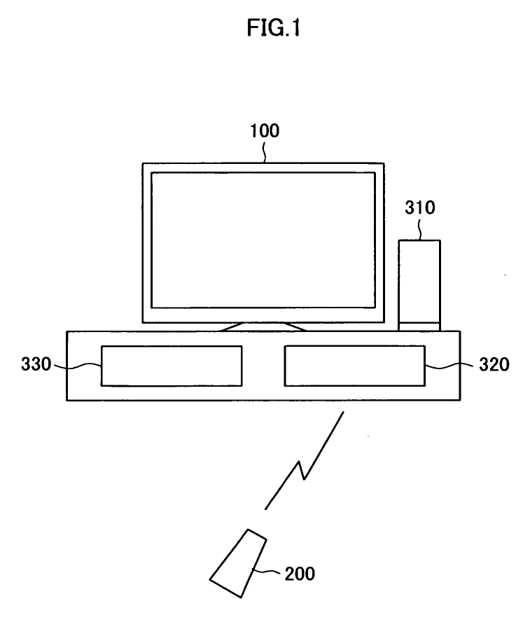

In the present embodiment, a television receiver 100 that is an example of an information processing device according to the present invention will be described. As shown in FIG. 1, the television receiver 100 according to the present embodiment is an information processing device that can be remotely operated by a remote controller 200, which is an external operation device. The television receiver 100 receives operation information output from the remote controller 200, and performs a predetermined process based on the operation information. Three external devices 310, 320 and 330, for example, are connected to the television receiver 100 according to the present embodiment. Switching of the input between the television receiver 100 and the external devices 310, 320 and 330 can also be performed by the remote controller 200.

### Configuration of the Television Receiver

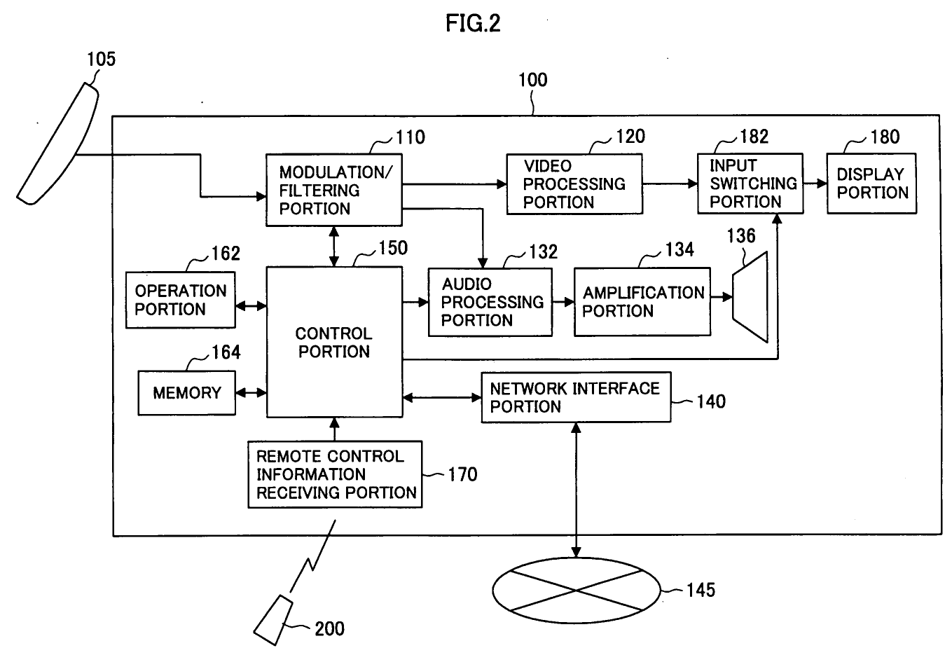

First, a schematic configuration of the television receiver 100 according to the embodiment of the present invention will be described with reference to FIG. 2. FIG. 2 is a block diagram showing the schematic configuration of the television receiver 100 according to the present embodiment.

As shown in FIG. 2, the television receiver 100 according to the present embodiment includes a demodulation/filtering portion 110, a video processing portion 120, an audio processing portion 132, a speaker 136, a network interface portion 140, a control portion 150, a remote control information receiving portion 170, and a display portion 180.

The demodulation/filtering portion 110 is a processing portion that demodulates a broadcast wave received by the antenna 105, and performs filtering in order to obtain predetermined information. The demodulation/filtering portion 110 extracts a transport stream from the demodulated broadcast wave, and obtains video, audio, program information and the like in accordance with a user's channel selection. The demodulation/filtering portion 110 outputs the obtained pieces of information to the video processing portion 120, the audio processing portion 132, and the control portion 150.

The video processing portion 120 is a functional portion that processes the video information input from the demodulation/filtering portion 110. The video processing portion 120 performs a predetermined process on the video information, obtains video data for display on the display portion 180, and outputs the video data to the input switching portion 182.

The audio processing portion 132 is a functional portion that processes the audio information input from the demodulation/filtering portion 110. The audio processing portion 132 performs a predetermined process on the audio information to generate audio data, and outputs the generated audio data to an amplification portion 134. The amplification portion 134 amplifies the audio data, and outputs it to a speaker 136. The speaker 136 outputs the audio data to provide audio to the user.

The network interface portion 140 is a functional portion that transmits and receives information to and from an external device via a network 145. The network interface portion 140 receives Internet information supplied from an external network server, or transmits and receives information to and from an external device connected via the network 145. Further, the network interface portion 140 is connected to the control portion 150, described later, and is capable of outputting information received via the network 145 to the control portion 150. The network interface portion 140 is also capable of transmitting information of the television receiver 100 to an external device.

The control portion 150 is a functional portion that controls each functional portion such that a predetermined operation is performed in the television receiver 100. The control portion 150 obtains program information from the demodulation/filtering portion 110. Further, the control portion 150 receives the network information received from the network interface portion 140 via the network 145. Furthermore, the control portion 150 obtains user operation information that is input from an operation portion 162 and the remote control information receiving portion 170 of the television receiver 100, which will be described later. The control portion 150 stores the information received from each functional portion in a memory 164 as necessary.

The control portion 150 performs processing to perform a predetermined action based on the operation information received from the operation portion 162 and the remote control information receiving portion 170. The control portion 150 outputs instruction information for switching the display content of the display portion 180 to the input switching portion 182, described later, or outputs instruction information for changing a sound volume to the audio processing portion 132. Further, the control portion 150 outputs to the modulation/filtering portion 110 setting change information for changing the settings of video information, or outputs to the interface portion 140 information about the television receiver 100 that is transmitted to an external device connected via the network 145. The control portion 150 is also capable of outputting, to the operation portion 162, response information with respect to the instruction information input from the operation portion 162.

The remote control information receiving portion 170 is a functional portion that receives operation information transmitted from the remote controller 200 for remotely operating the television receiver 100. The remote control information receiving portion 170 receives, for example, infrared rays or wireless radio waves output from the remote controller 200, and outputs them to the control portion 150. The remote control information receiving portion 170 can be formed of one or more light reception portions capable of receiving infrared rays, or a reception portion capable of receiving wireless radio waves.

The display portion 180 is a functional portion that receives video data output from the video processing portion 120 via the input switching portion 182, and displays the video data. For example, a liquid crystal display, a plasma display or the like can be used as the display portion 180. Information displayed on the display portion 180 can be operated using the operation portion 162 or the remote controller 200.

The overall configuration of the television receiver 100 according to the present embodiment has been described above. As shown in FIG. 1, one or more of the external devices 310, 320 and 330, such as a game console, a playback device, a recording device, a personal computer etc., can be connected to the television receiver 100 configured as described above. The user can switch the input between the main body of the television receiver 100 and the eternal devices 310, 320 and 330 using the operation portion 162 or the remote controller 200. Moreover, the user can use the remote controller 200 to operate a desired device, adjust the display or sound volume of video information or audio information supplied from these devices, select a channel, and perform other operations.

As described above, the operation of the television receiver using the remote controller tends to become more troublesome, as the functions of the television receiver increase or as the number of the external devices connected to the television receiver increases. To address the above problem, the television receiver 100 according to the present embodiment includes an operation control portion 190. In order to simplify the operation of the television receiver 100 using the remote controller 200, the operation control portion 190 controls the operation of the television receiver 100, based on the operation of the television receiver 100 and an intuitive action of the user that are associated with each other in advance.

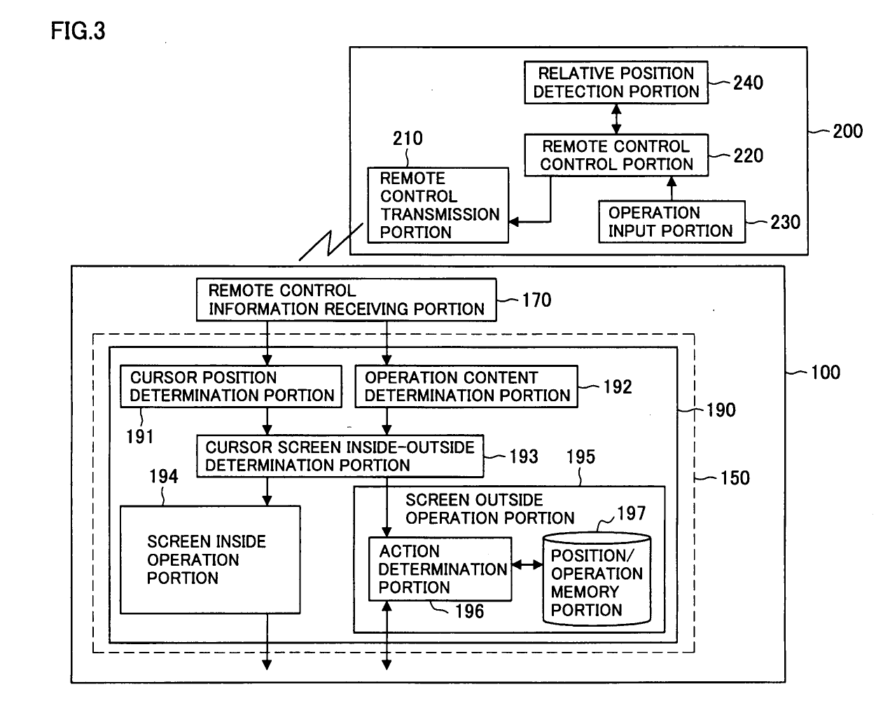

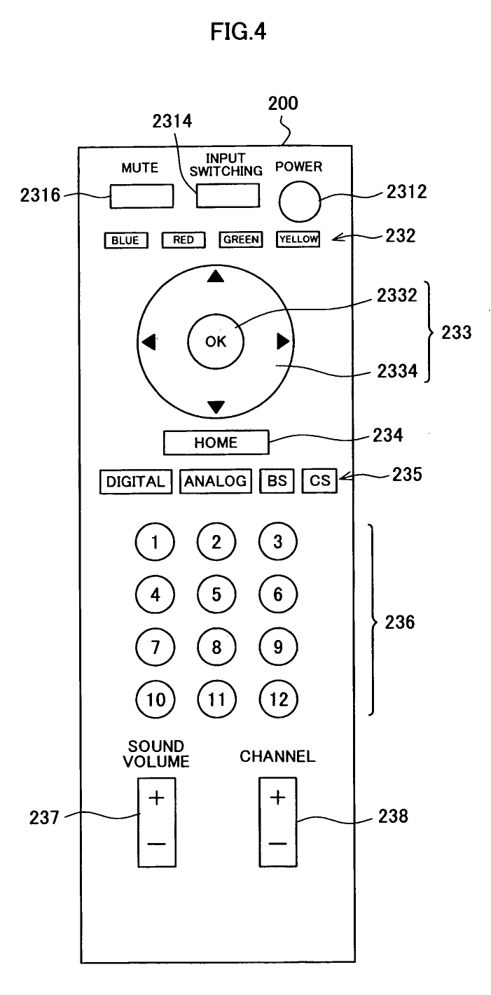

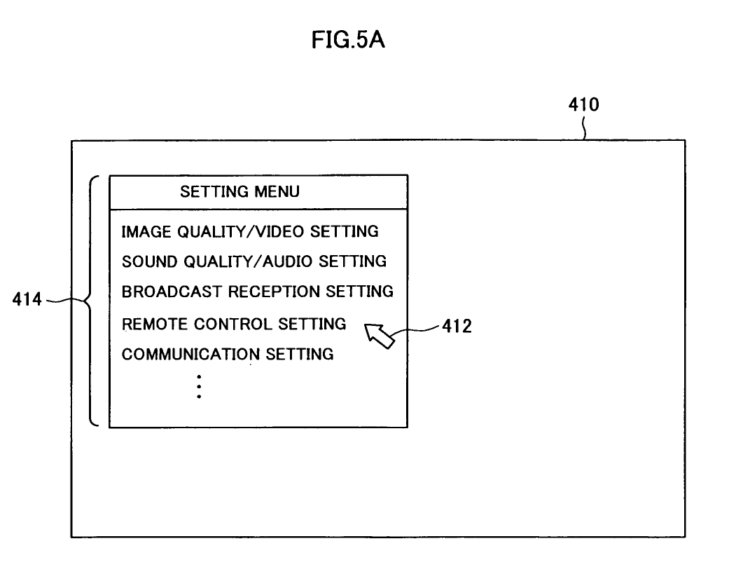

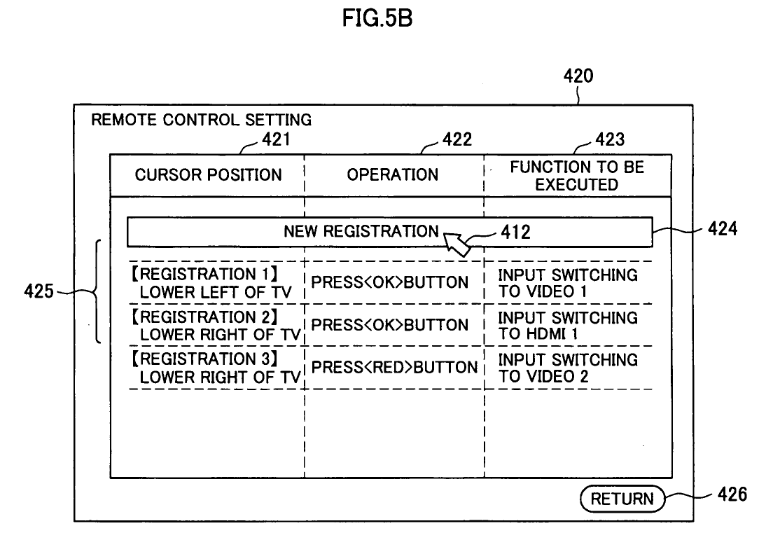

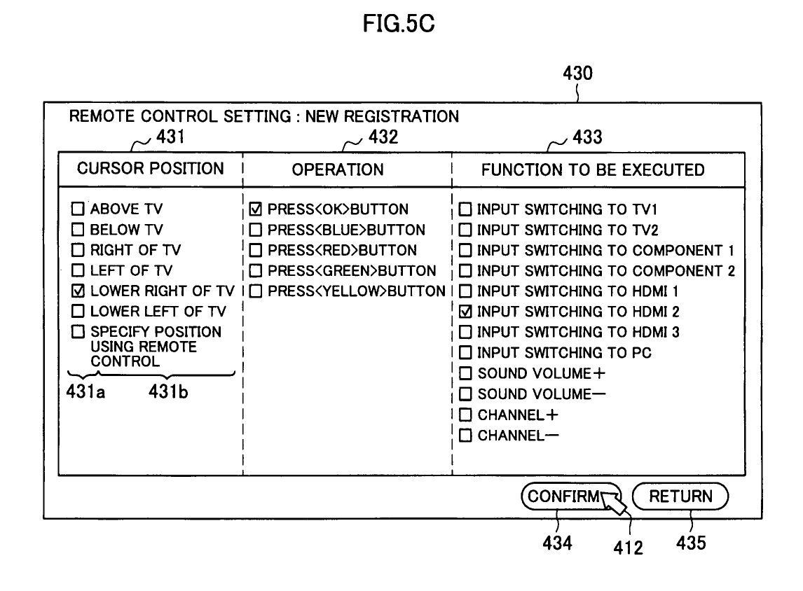

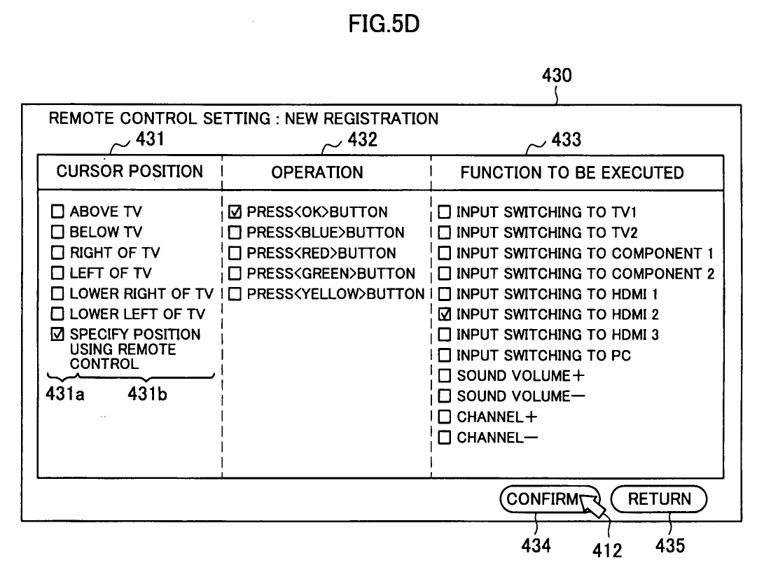

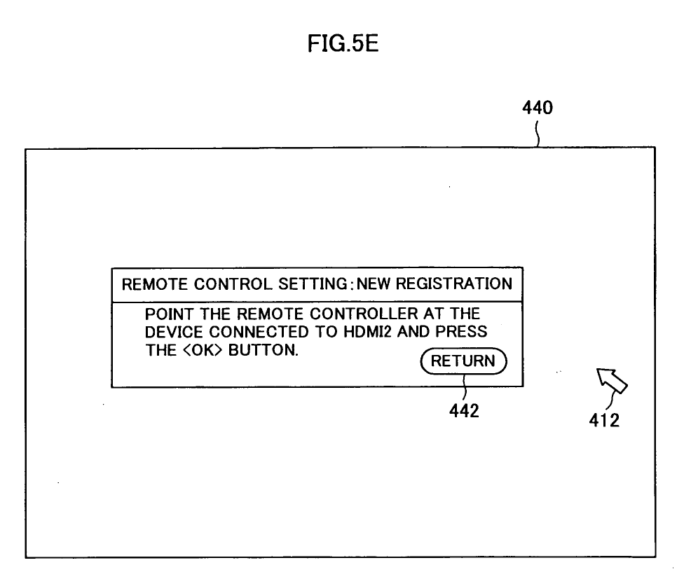

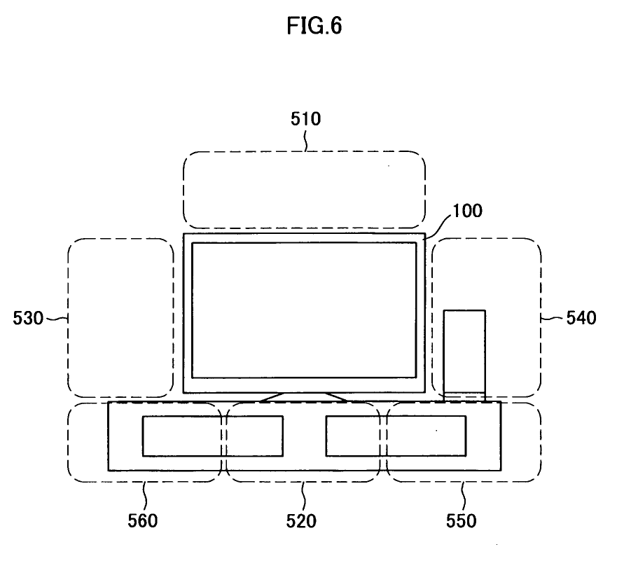

Next, the configuration and operation processes of the operation control portion 190 according to the present embodiment will be described with reference to FIG. 3 to FIG. 6. FIG. 3 is a block diagram showing the configurations of the operation control portion 190 and the remote controller 200 according to the present embodiment. FIG. 4 is a plan view showing an example of the remote controller 200. FIG. 5A to FIG. 5E are explanatory diagrams each showing a screen that is displayed on the display portion 180 when device control information is registered in a position/operation memory portion 197. FIG. 6 is an explanatory diagram showing relative positions with respect to the television receiver 100.

### Configuration of the Remote Controller and the Operation Control Portion of the Television Receiver

The television receiver 100 according to the present embodiment receives operation information transmitted from the remote controller 200, and performs control such that the operation control portion 190 performs an operation in accordance with the operation information. The operation control portion 190 can be provided, for example, in the control portion 150 shown in FIG. 2.

The configuration of the remote controller 200 will now be described. As shown in FIG. 3, the remote controller 200 according to the present embodiment includes a remote control transmission portion 210, a remote control control portion 220, an operation input portion 230, and a relative position detection portion 240.

The remote control transmission portion 210 is a functional portion that transmits operation information transmitted from the remote control control portion 220, to the remote control information receiving portion 170 of the television receiver 100. For example, a light emission portion that can emit infrared rays, or a wireless transmission IC that can output wireless radio waves can be used as the remote control transmission portion 210.

The remote control control portion 220 is a control portion that generates operation information for operating the television receiver 100. The remote control control portion 220 generates the operation information for operating the television receiver 100, based on the information input from the operation input portion 230 and the relative position detection portion 240. The operation information includes, for example, a direction signal (instructed position information) that indicates a direction in which the remote controller 200 is pointed, and a content signal (operation content information) that indicates an action performed with respect to the remote controller 200 by the user. The remote control control portion 220 outputs the generated operation information to the remote control transmission portion 210 and the relative position detection portion 240.

The operation input portion 230 is a functional portion that inputs information for operating the television receiver 100. Examples of the operation input portion 230 include, for example, one or more buttons, and a cursor movement key. The operation input portion 230 outputs information about the button or the key pressed by the user to the remote control control portion 220.

FIG. 4 shows an example of the remote controller 200. The remote controller 200 can include: a power button 2312 used to turn on and off a power source of the television receiver 100; an input switching button 2314 used to switch the input between the television receiver 100 and the external devices 310, 320 and 330; and a mute button 2316 used to turn off audio output from the speaker 136. Further, the remote controller 200 can include function buttons 232 used to perform respective predetermined processes associated with each function button; a cursor operation key 233 that has a movement key 2334 used to move the cursor displayed on the display portion 180 in an up, down, left or right direction, and an OK button 2332 used to decide on a selected target that is selected by the cursor; and a home key 234 used to move to a predetermined home screen that has been set in advance. Furthermore, the remote controller 200 can include: switching buttons 235 used to switch between digital broadcast, analog broadcast, BS broadcast and communication satellite (CS) broadcast; numeric keys 236; a sound volume key 237 used to adjust sound volume; and a channel key 238 used to change the displayed channel.

The relative position detection portion 240 is a functional portion that detects a relative position of the remote controller 200 itself. For example, an inertia sensor or a gyro can be used as the relative position detection portion 240. The relative position detection portion 240 detects the position or posture of the remote controller 200, and outputs the detected information to the adjustment portion 250. As a result of providing the relative position detection portion 240, the remote controller 200 according to the present embodiment is able to operate the television receiver 100 in response to the posture or movement of the remote controller 200.

The configuration of the remote controller 200 has been described above. The operation information, which is input from the operation input portion 230 by the user, or input by the user moving the remote controller 200 itself, is transmitted from the remote control transmission portion 210 and received by the remote control information receiving portion 170 of the television receiver 100. The remote control information receiving portion 170 outputs the received operation information to the operation control portion 190.

As shown in FIG. 3, the operation control portion 190 according to the present embodiment includes a cursor position determination portion 191, an operation content determination portion 192, a cursor screen inside-outside determination portion 193, a screen inside operation portion 194, and a screen outside operation portion 195.

The cursor position determination portion 191 is a processing portion that determines the direction in which the remote controller 200 is pointed, based on the operation information received from the remote controller 200. The cursor position determination portion 191 analyzes a direction signal included in the operation information, and determines at which position on the screen plane of the display portion 180 the remote controller 200 is pointed. Note that, the screen plane includes the outside of the television receiver 100. Then, the cursor position determination portion 191 generates cursor position information that indicates the position on the screen plane of the display portion 180 at which the remote controller 200 is pointed, and outputs the cursor position information to the cursor screen inside-outside determination portion 193.

The operation content determination portion 192 is a processing portion that determines the content of the operation of the remote controller 200 performed by the user. The operation content determination portion 192 analyzes a content signal included in the operation information, and determines what kind of action is performed with respect to the remote controller 200, such as pressing a button of the remote controller 200, or shaking the remote controller 200. The operation content determination portion 192 generates operation content information that indicates the action performed with respect to the remote controller 200 by the user, and generates the operation content information to the cursor screen inside-outside determination portion 193.

The cursor screen inside-outside determination portion 193 is a processing portion that determines whether the position at which the remote controller is pointed is on the inside of the screen of the display portion 180 of the television receiver 100. The cursor screen inside-outside determination portion 193 determines whether the position indicated by the cursor position information input from the cursor position determination portion 191 is on the inside of the screen of the display portion 180. When it is determined that the position indicated by the cursor position information is on the inside of the screen of the display portion 180, the cursor screen inside-outside determination portion 193 outputs the cursor position information and the operation content information to the screen inside operation portion 194. On the other hand, when it is determined that the position indicated by the cursor position information is on the outside of the screen of the display portion 180, the cursor screen inside-outside determination portion 193 outputs the cursor position information and the operation content information to the screen outside operation portion 195.

The screen inside operation portion 194 is a functional portion that performs an operation process of the television receiver 100 when the position indicated by the cursor position information is on the inside of the screen. The screen inside operation portion 194 performs a normal operation process of the television receiver 100 based on the cursor position information and the operation content information. An example of a screen inside operation process will be described later.

The screen outside operation portion 195 is a functional portion that performs an operation process of the television receiver 100 when the position indicated by the cursor position information is on the outside of the screen. As shown in FIG. 3, the screen outside operation portion 195 includes an action determination portion 196 and the position/operation memory portion 197. The action determination portion 196 functions as an action information acquisition portion that acquires device control information that is stored in advance in the position/operation memory portion 197. The action determination portion 196 operates the television receiver 100 based on the acquired device control information. The position/operation memory portion 197 is a memory portion (an action information memory portion) that associates and stores the cursor position information and the operation content information, and the device control information. The position/operation memory portion 197 stores the device control information that is executed when the position indicated by the cursor position information is on the outside of the screen of the display portion 180.

The association of the cursor position information and the operation content information with the device control information, which are stored in the position/operation memory portion 197, can be performed by a user on a remote control setting screen, for example. When the user newly sets the device control information, first, the user displays, for example, a setting menu screen 410 that is used to perform setting of the television receiver 100 as shown in FIG. 5A. Then, the user selects “remote control setting” from setting items 414 displayed on the setting menu screen 410, using a cursor 412. If the “remote control setting” selected by the cursor 412 is decided on using the OK button 2332, the screen shifts from the setting menu screen 410 to a remote control setting screen 420.

As shown in FIG. 5B, a cursor position 421, operation information 422, and a function to be executed (device control information) 423 are displayed on the remote control setting screen 420. The information that has already been associated and stored is displayed as registered information 425, such as “registration 1”, “registration 2” and “registration 3”. When the cursor position information and the operation content information are newly associated with the device control information, the user presses a new registration button 424 using the cursor 412 to shift to a new registration screen 430.

As shown in FIG. 5C, items 431b and check boxes 431a are displayed on the new registration screen 430. The items 431b can be respectively associated with a cursor position 431, operation information 432, and a function to be executed (device control information) 433. The check boxes 431a are used to select each item. The user places a check in one of the check boxes for each of the cursor position 431, the operation information 432, and the function to be executed (the device control information) 433.

Note that the cursor position 431 can be expressed as, for example, a relative position with respect to the television receiver 100. For example, as shown in FIG. 6, a region 510 above the television receiver 100 when viewed from the user can be expressed as “above TV”, and a region 520 below the television receiver 100 can be expressed as “below TV”. A left side region 530 can be expressed as “left of TV”, a right side region 540 as “right of TV”, a lower right side region 550 as “lower right of TV”, and a lower left side region 560 as “lower left of TV”. Note that the position and size of each region shown in FIG. 6 are only examples, and the regions may be set separately.

In the new registration screen 430 shown FIG. 5C, the cursor position is located on the “lower right of TV”. When the operation “press <OK> button” is performed on the remote controller 200, a process that performs “input switching to HDMI2” is ready to be registered. Then, if a confirm button 434 is pressed with the cursor 412, the content that has been input to the new registration screen 430 is registered. If a new registration is not performed, the user can return to the previous screen (the remote control setting screen 420) shown in FIG. 5B, by pressing a return button 435.

Further, the cursor position 431 can also be specified using the position of the remote controller 200 in the new registration screen 430. It is assumed that, when the new registration button 424 is pressed on the remote control setting screen 420 shown in FIG. 5B to shift to the new registration screen 430, the user places a check in one of the check boxes 431a corresponding to the item “specify position using remote control” in the cursor position 431 field, and presses the confirm button 434 as shown in FIG. 5D. In this case, the screen shifts from the new registration screen 430 shown in FIG. 5D to a cursor position setting screen 440 in order to finally decide the cursor position 431.

As shown in FIG. 5E, an instruction to the user is displayed on the cursor position setting screen 440. For example, if the operation information 432 has been set to “press <OK> button” and the function to be executed 433 has been set to “input switching to HDMI2” in the previous screen shown in FIG. 5D, the instruction “Point the remote controller 200 at the device connected to HDMI2 and press the <OK> button.” is displayed as shown in FIG. 5E. The user moves the remote controller 200 and presses the OK button 2332 in accordance with the instruction. By doing this, the cursor position is determined based on the operation information transmitted from the remote controller 200. Then, the cursor position is associated with the operation information 432 and the function to be executed 433, and registered in the position/operation memory portion 197. If the user does not register the cursor position, the user can return to the remote control setting screen 420 shown in FIG. 5D by pressing a return button 442.

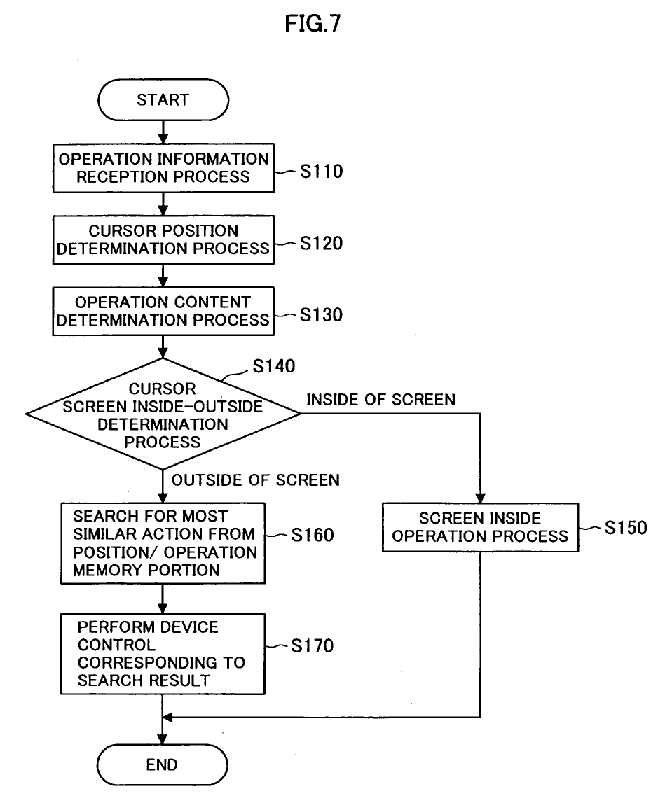

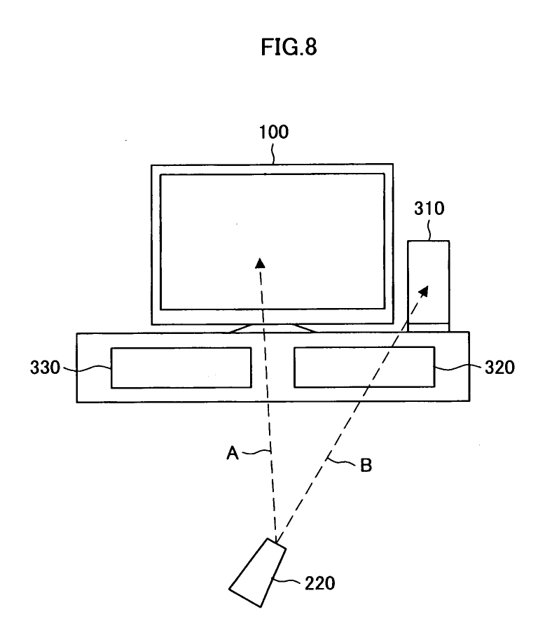

This completes the description of the configuration of the operation control portion 190 according to the present embodiment. Next, an operation control process performed by the operation control portion 190 according to the present embodiment will be described with reference to FIG. 7 and FIG. 8. FIG. 7 is a flowchart showing the operation control process performed by the operation control portion 190 according to the present embodiment. FIG. 8 is an explanatory diagram illustrating a direction in which the remote controller 200 is pointed toward the television receiver 100.

### Operation Control Process

As shown in FIG. 7, in the operation control process according to the present embodiment, first, the remote control information receiving portion 170 of the television receiver 100 receives operation information from the remote controller 200 (step S110). The remote control information receiving portion 170 receives, as the operation information, a direction signal (instructed position information) that indicates the direction in which the remote controller 200 is pointed, and a content signal (operation content information) that indicates the action performed with respect to the remote controller 200 by the user. The remote control information receiving portion 170 outputs the received operation information to the cursor position determination portion 191 and the operation content determination portion 192.

Then, the cursor position determination portion 191 determines the cursor position (step S120). The cursor position determination portion 191 analyzes the direction signal included in the operation information received from the remote controller 200, and determines the direction in which the remote controller 200 is pointed. The cursor position determination portion 191 generates cursor position information that indicates the position on the screen plane of the display portion 180 at which the remote controller 200 is pointed, and outputs the cursor position information to the cursor screen inside-outside determination portion 193.

Further, the operation content determination portion 192 determines the content of the operation that has been performed with respect to the remote controller 200 (step S130). The operation content determination portion 192 analyzes the content signal included in the operation information received from the remote controller 200, and determines what kind of action has been performed with respect to the remote controller 200. The operation content determination portion 192 generates operation content information based on the determination result, and outputs the operation content information to the cursor screen inside-outside determination portion 193.

After that, the cursor screen inside-outside determination portion 193 determines whether the cursor position is on the inside of the screen of the display portion 180 (step S140). Before the cursor screen inside-outside determination process is performed, an initial adjustment is performed for identifying the screen region. For example, the remote controller 200 is pointed at the four corners of the screen, and an operation of the operation input portion 230, such as pressing the OK button 2332, is performed at each position. The remote control information receiving portion 170 receives the operation information relating to the operation performed at each position, and identifies the screen region of the display portion 180. The cursor screen inside-outside determination portion 193 determines whether the position indicated by the cursor position information that is received after the initial adjustment has been performed is on the inside or outside of the screen of the display portion 180.

When it is determined at step S140 that the position indicated by the cursor position information is on the inside of the screen of the display portion 180, the screen inside operation portion 194 performs the screen inside operation process (step S150). The screen inside operation portion 194 performs a normal operation process of the television receiver 100, based on the cursor position information and the operation content information. In the screen inside operation process, for example, a cursor is displayed at the position on the screen indicated by the cursor position information. Further, when an operation such as pressing a button of the remote controller 200 is performed in a state where the cursor is on a button, an icon or the like, a function that is associated in advance with the button, the icon or the like is executed. Further, for example, when a button of the remote controller 200 is pressed in a state where the cursor is on an icon that indicates a channel number, the channel may be switched to the corresponding channel. Moreover, when a button of the remote controller 200 is pressed in a state where the cursor is on an icon that indicates a specific external input terminal, the input may be switched to the external input terminal.

On the other hand, when it is determined at step S140 that the position indicated by the cursor position information is on the outside of the screen of the display portion 180, the screen outside operation portion 195 performs a screen outside operation process. In the screen outside operation process, first, the position/operation memory portion 197 is searched for an action corresponding to the cursor position information and the operation content information (step S160). As described above, the cursor position information and the operation content information are associated with the device control information, and they are stored in the position/operation memory portion 197. At step S160, the action determination portion 196 searches the position/operation memory portion 197 for registration information which has operation information that is the same as the operation content information based on the operation information from the remote controller 200 and which has cursor position information that is similar to the cursor position information based on the operation information.

Note that the determination about the similarity of the cursor position information can be made, based on whether or not a distance (an error) of the cursor position information is equal to or lower than a predetermined value. For example, a Euclidian distance or a Manhattan distance can be used as a measure of the distance of the cursor position information. When the operation information is the same as the operation content information based on the operation information, and when there are a plurality of pieces of registration information having the distance of the cursor position information that is equal to or lower than the predetermined value, the registration information having the minimum distance of the cursor position information can be selected. Thus, it is possible to select the registration information that is most similar to the operation content information and the cursor position information based on the operation information.

After the action determination portion 196 has acquired a piece of registration information from the position/operation memory portion 197, the action determination portion 196 performs a process that executes the function to be executed by the acquired registration information (step S170).

This completes the description of the operation control process according to the present embodiment. The television receiver 100 according to the present embodiment determines the direction (the cursor position information) in which the remote controller 200 is pointed, based on the operation information transmitted from the remote controller 200. Then, the television receiver 100 determines whether or not the position indicated by the cursor position information is on the inside or outside of the screen of the display portion 180. Then, the cursor screen inside-outside determination portion 193 determines that either the screen inside operation process or the screen outside operation process is to be performed, based on the determination result. Thus, if a predetermined action, such as pressing the OK button 2332, is performed while the remote controller 200 is pointed toward the outside of the screen of the display portion 180, it is possible to execute a function that the user expects to occur in association with the action. Therefore, the operation of the television receiver 100 with the remote controller 200 can be simplified, and user operability can be improved.

For example, let us assume that a game console connected to the external input terminal HDMI1 is provided on the right side of the television receiver 100, a recording device connected to the external input terminal HDMI2 is provided on the lower left side, and a playback device connected to the external input terminal HDMI3 is provided on the lower right side. Further, let us assume that the following information is stored in advance in the position/operation memory portion 197: “right of TV” of the cursor position information, “press <OK> button” of the operation information, and “input switching to HDMI1” of the function to be executed, which are stored as first registration information; “lower left of TV” of the cursor position information, “press <OK> button” of the operation information, and “input switching to HDMI2” of the function to be executed, which are stored as second registration information; and “lower right of TV” of the cursor position information, “press <OK> button” of the operation information, and “input switching to HDMI3” of the function to be executed, which are stored as third registration information.

For example, let us assume that the user performs an operation while pointing the remote controller 200 in the A direction as shown in FIG. 8. At this time, the cursor screen inside-outside determination portion 193 determines that the position indicated by the cursor position information is on the inside of the screen of the display portion 180, and issues an instruction to perform the screen inside operation process to the screen inside operation portion 194.

On the other hand, let us assume that the user performs the operation while pointing the remote controller 200 in the B direction as shown in FIG. 8. At this time, the cursor screen inside-outside determination portion 193 determines that the position indicated by the cursor position information is on the outside of the screen of the display portion 180, and issues an instruction to perform the screen outside operation process to the screen outside operation portion 195. In this case, if the user presses the OK button 2332 while pointing the remote controller 200 in the B direction, the action determination portion 196 searches the position/operation memory portion 197 and acquires the first registration information corresponding to that process. Then, the action determination portion 196 performs the process “input switching to HDMI1”, which is the function to be executed in the first registration information.

The operation process according to the present embodiment can be applied not only to the above-described external input switching process, but also to a channel selection process or a volume adjustment process of the television receiver 100. For example, when the user directs the remote controller 200 toward the upper side of the television receiver 100 while pressing a predetermined button, the next channel is selected or sound volume is increased. Conversely, when the user directs the remote controller 200 toward the lower side of the television receiver 100 while pressing the predetermined button, the previous channel is selected, or sound volume is reduced. In this manner, if a predetermined process is associated with an action that the user can easily and intuitively perform, for example, directing the remote controller 200 to the outside of the screen of the display portion 180 and performing a predetermined operation, the predetermined process can be executed without requiring complicated button operations.

It should be understood by those skilled in the art that various modifications, combinations, sub-combinations and alterations may occur depending on design requirements and other factors insofar as they are within the scope of the appended claims or the equivalents thereof.

In the above-described embodiment, the position/operation memory portion 197 stores the registration information that has been set in advance by the user. However, the present invention is not limited to the above example. For example, the registration information may be stored in advance when the television receiver 100 is manufactured.

The present application contains subject matter related to that disclosed in Japanese Priority Patent Application JP 2008-141773 filed in the Japan Patent Office on May 30, 2008, the entire content of which is hereby incorporated by reference.

What is claimed is:

1. An information processing device comprising:
a display portion that displays an image;
a receiving portion that receives operation information transmitted from an external operation device;
a content determination portion that determines, based on the received operation information, an instructed position and an operation content that are instructed by the external operation device with respect to the display portion;
a screen inside-outside determination portion that determines whether the instructed position is on an inside of the display portion; and
a screen outside operation portion that performs control such that an action in accordance with the instructed position and the operation content is performed when it is determined that the instructed position is on an outside of the display portion.

2. The information processing device according to claim 1, wherein
the screen outside operation portion includes:
an action information memory portion that stores at least one piece of registration information in which the instructed position and the operation content are associated with action control information that indicates an action content that is performed with respect to the information processing device; and
an action information acquisition portion that acquires, from the action information memory portion, the action control information corresponding to the instructed position and the operation content based on the operation information received from the external operation device.

3. The information processing device according to claim 2, wherein
the action information acquisition portion searches the action information memory portion for registration information that matches the operation content based on the operation information and that is similar to the instructed position based on the operation information, and acquires action control information of the corresponding registration information.

4. The information processing device according to claim 3, wherein
the action information acquisition portion searches the action information memory portion for registration information indicating that a distance from the instructed position based on the operation information is the closest possible and equal to or less than a predetermined distance, and acquires action control information of the corresponding registration information.

5. The information processing device according to claim 2, wherein
the action control information is input switching information that switches an input between the information processing device and a device connected to the information processing device, and
when the instructed position and the operation content based on the operation information correspond to a predetermined instructed position and a predetermined operation content on the outside of the display portion that have been associated in advance with the input switching information, the action information acquisition portion acquires the input switching information from the action information memory portion and switches the input between the information processing device and the device connected to the information processing device.

6. The information processing device according to claim 2, wherein
the action control information is channel selection information that selects a channel of the information processing device, and
when the instructed position and the operation content based on the operation information correspond to a predetermined instructed position and a predetermined operation content on the outside of the display portion that have been associated in advance with the channel selection information, the action information acquisition portion acquires the channel selection information from the action information memory portion and selects the channel.

7. The information processing device according to claim 2, wherein
the action control information is sound volume adjustment information that adjusts a sound volume of the information processing device, and
when the instructed position and the operation content based on the operation information correspond to a predetermined instructed position and a predetermined operation content on the outside of the display portion that have been associated in advance with the sound volume adjustment information, the action information acquisition portion acquires the sound volume adjustment information from the action information memory portion and adjusts the sound volume.

8. The information processing device according to claim 1, wherein
the content determination portion includes:
a position determination portion that determines, based on the operation information, an instructed position that indicates a position at which the external operation device is pointed with respect to the display portion; and
an operation content determination portion that determines, based on the operation information, an operation content performed with respect to the external operation device by a user.

9. The information processing device according to claim 8, wherein
the position determination portion uses, as a measure for determination, one of a Euclidian distance and a Manhattan distance to indicate the instructed position.

10. The information processing device according to claim 1, further comprising:
a screen inside operation portion that operates a cursor that is displayed on the display portion based on the instructed position and the operation content when it is determined that the instructed position is on the inside of the display portion.

11. An information processing method, comprising the steps of:
receiving operation information transmitted from an external operation device;
determining, based on the received operation information, an instructed position and an operation content that are instructed by the external operation device;
determining whether the instructed position is on an inside of a display portion that displays an image; and
performing control such that an action in accordance with the instructed position and the operation content is performed when it is determined that the instructed position is on an outside of the display portion.
